(19) United States
(12) Patent Application Publication
(10) Pub. No.: US 2017/0275742 A1
(43) Pub. Date: Sep. 28, 2017

(54) CERAMIC AND METAL BORON NITRIDE NANOTUBE COMPOSITES

(71) Applicant: A. Jacob Ganor, Kowloon (HK)

(72) Inventor: A. Jacob Ganor, Kowloon (HK)

(21) Appl. No.: 15/456,872

(22) Filed: Mar. 13, 2017

Related U.S. Application Data
(60) Provisional application No. 62/307,282, filed on Mar. 11, 2016.

(51) Int. Cl. C22C 38/14; C04B 35/626; C04B 35/645; C22C 38/12; B22F 7/00; C22C 38/06; C22C 38/00; C22C 33/02; B22F 9/04; B22F 3/16; C04B 35/80; C22C 38/10

(52) U.S. Cl. CPC C22C 38/14; C04B 35/806; C04B 35/6261; C04B 35/645; C22C 38/12; C22C 38/105; C22C 38/06; C22C 38/002; C22C 33/0228; C22C 33/0285; B22F 9/04; B22F 3/16; B22F 7/008; C04B 2235/3817; C04B 2235/3804; C04B 2235/5284; C04B 2235/602; B22F 2009/043; B22F 2301/35; B22F 2302/205; B22F 2302/35; B22F 2998/10

(57) ABSTRACT

The present invention provides for materials and methods of making metal and ceramic matrix composites reinforced with boron nitride nanomaterials for improved physical properties such as hardness, fracture toughness, and bend strength.

### CROSS-REFERENCE TO RELATED APPLICATIONS

The present application for patent claims priority to U.S. Provisional Application No. 62/307,282, entitled “CERAMIC AND METAL BORON NITRIDE NANOTUBE COMPOSITES,” filed Mar. 11, 2016, and hereby expressly incorporated by reference herein.

### BACKGROUND OF THE INVENTION

1. Field of the Invention

The present disclosure relates to metal and ceramic matrix composites reinforced with boron nitride nanomaterials for improved physical properties such as hardness, fracture toughness, and bend strength.

2. Description of the Related Art

Boron nitride nanomaterials possess the ability to improve the mechanical properties of hard materials. Boron nitride nanotubes, nanoplatelets, and nanosheets can improve the ductility of monolithic ceramics and high-hardness steels. Cubic or wurtzite boron nitride nanocrystals can improve the hardness of monolithic ceramics and high-hardness steels. It is the aim of this invention to provide ceramic and steel composites with improved mechanical properties, through their reinforcement with boron nitride nanomaterials.

Monolithic ceramics possess many desirable physical and chemical properties such as high hardness, high strength, chemical inertness, high temperature resistance, and corrosion resistance. These desirable properties are coupled with inherent brittleness—associated with fracture toughnesses often under 1 MPa·m1/2—which makes ceramic materials poorly reliable under load, and poorly resistant to impact and other stressors.

The poor fracture toughness of monolithic ceramics can be overcome to some extent with the addition of a more ductile metal phase, thus creating a cermet. While cermets benefit from increased fracture toughness, they're typically of reduced hardness, strength, and chemical inertness when compared to monolithic ceramics. Moreover, cermets with desirable properties can be very difficult to manufacture, due to chemical reactivity between the metal and ceramic components.

Alternatively, the poor fracture toughness of monolithic ceramics can be partially overcome with fiber reinforcement, thus creating a ceramic fiber reinforced ceramic (CFRC). Although highly effective, this is associated with drawbacks including very high processing costs, and numerous processing difficulties. Carbon-based fibers degrade in oxidizing atmospheres at temperatures as low as 450° C., which limits their usefulness and complicates fabrication. Oxide fibers—alumina, for instance—have limited creep resistance and undergo grain growth at high temperatures. Also worth mentioning are the facts that internal pores in fiber/ceramic composites are unavoidable, and that complex shapes are extremely difficult if not impossible to manufacture.

The infiltration of monolithic ceramics with carbon nanomaterials—such as carbon nanotubes and graphene—has been investigated in recent years. Results have heretofore been mixed; carbon nanotubes and graphene both impart a toughening effect in some cases, but provide no benefit—in fact may weaken the ceramic matrix—in other cases. Processing difficulties likely account for this, as carbon nanomaterials can easily degrade at the high temperatures used for ceramic sintering, can react chemically with oxygen impurities or the materials which comprise the ceramic matrix itself, and are difficult to fully disperse in ceramic matrices.

In light of this, there is a pressing need for agents, which can improve the mechanical properties of bulk ceramic materials.

Likewise, steel generally possesses many desirable mechanical properties such as reasonable hardness, good strength, toughness and good ductility. However, high-hardness steels—such as tool steels and high-speed steels—are often brittle and exhibit poor ductility and fracture toughness. This limits their potential applications, despite their low cost and ease of manufacture.

The increasing demand from users of tool steels for better performance has led to the widespread use of steels spray-coated with thin layers of ceramic materials such as titanium nitride and titanium carbide, but these coatings occasionally need to be stripped and re-coated, are prone to oxidizing at temperatures as low as 550° C., and are expensive to apply.

There are no commercially available alternative solutions. Steel nanolaminates and nano-crystalline steels are in development, but their mechanical properties and suitability for use as high-speed tool steels have not been ascertained.

Furthermore, steel is still the most commonly used ballistic armor material, and thin ceramic coatings do not significantly enhance antiballistic performance.

There is, therefore, a clear and pressing need for agents, which can improve the toughness, ductility, and hardness of tool and armor steels.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 illustrates a flow chart of the process of making metal and ceramic matrix composites reinforced with boron nitride nanomaterials.

### DETAILED DESCRIPTION

In one aspect, the present disclosure provides a high-temperature stable, dispersable, scalable reinforcement for metals, and for carbide and boride ceramic matrices. In one or more embodiments, the metal is selected from molten aluminum, magnesium, titanium, nickel, copper, niobium, cobalt, lead, steel, or beryllium. In one preferred embodiment, the metal is steel.

For the methods described herein, metals may include but are not limited to, for example, magnesium, aluminum, titanium, manganese, iron, cobalt, nickel, copper, molybdenum, tungsten, palladium, chromium, ruthenium, gold, silver, zinc, zirconium, vanadium, silicon, or a combination thereof and including alloys thereof. In some aspects, the metal can be an aluminum-based alloy, magnesium-based alloy, tungsten-based alloy, cobalt-based alloy, iron-based alloy, nickel-based alloy, cobalt and nickel-based alloy, iron and nickel-based alloy, iron and cobalt-based alloy, copper-based alloy, and titanium-based alloy. As used herein, the term “metal-based alloy” means a metal alloy wherein the weight percentage of the specified metal in the alloy is greater than the weight percentage of any other component of the alloy, based on the total weight of the alloy. In some aspects, metal alloys include MgZrZn, MgAlZn, AlCuZnMn, and AlMgZnSiMn. Metal oxides and metal carbides include the metals listed above. Exemplary metal oxides and metal carbides include aluminum oxide (Al₂O₃), magnesium oxide, and tungsten carbide.

At least one embodiment of the present invention proposes reinforcing ceramic or steel matrices with boron nitride nanotubes. The mechanical properties of individual boron nitride nanotubes are highly similar to those of individual carbon nanotubes; the boron nitride nanotubes exhibit a nearly identical elastic modulus of ˜1.3 TPa and a roughly analogous strength of 33 GPa. The thermal stability of boron nitride nanotubes vastly exceeds that of carbon nanotubes, and the oxidative stability of boron nitride nanotubes also far exceeds that of carbon nanotubes. Furthermore, boron nitride nanotubes are highly dispersable in ceramic or steel matrices, if appropriate techniques are employed.

In one or more embodiments, the present invention provides for incorporating nanotubular inclusions such as carbon nanotubes (“CNTs” that includes single wall nanotube (“SWNT” or “SWCNT”), few walled carbon nanotubes (“FWNTs”) and multiwall carbon nanotubes (“MWNT”)); boron nitride nanotubes (“BNNTs” in the same variations of single wall, few wall, and multiwall configurations as CNTs); and combinations of CNTs and BNNTs, into the host matrix.

In one embodiment, the materials of the present invention provide for a ceramic or steel matrix composite reinforced with an effective amount of a nanotubular inclusion agent is selected from the group consisting of carbon nanotubes, boron nitride nanotubes, and mixtures thereof. Furthermore, excellent results are achieved when the nanotubes are non-functionalized and are selected from the group consisting of single wall nanotubes, few wall nanotubes, multiwall nanotubes, and combinations thereof.

In certain embodiments of the invention, effective amounts of nanomaterial inclusions are utilized in the matrix material. In one or more embodiments, the nanomaterial inclusion agent is present in the composite material made by the methods of the present invention in an amount of about 20 wt % or less. In other embodiments, the agent is present in an amount of about 10 wt % or less. In other embodiments, the agent is present in an amount of about 5 wt % or less. In yet other embodiments, the agent is present in an amount of about 0.1 wt % to about 5 wt %. In yet other embodiments, the agent is present in an amount of about 0.2 wt % to about 4 wt %. In yet other embodiments, the agent is present in an amount of about 0.2 wt % to about 3 wt %.

The term “nanomaterial,” as used herein, includes, but is not limited to, functionalized and solubilized multi-wall carbon or boron nitride nanotubes, single-wall carbon or boron nitride nanotubes, carbon or boron nitride nanoparticles, carbon or boron nitride nanofibers, carbon or boron nitride nanoropes, carbon or boron nitride nanoribbons, carbon or boron nitride nanofibrils, carbon or boron nitride nanoneedles, carbon or boron nitride nanosheets, carbon or boron nitride nanorods, carbon or boron nitride nanohoms, carbon or boron nitride nanocones, carbon or boron nitride nanoscrolls, graphite nanoplatelets, nanodots, other fullerene materials, or a combination thereof. The term “nanotubes” is used broadly herein and, unless otherwise qualified, is intended to encompass any type of nanomaterial. Generally, a “nanotube” is a tubular, strand-like structure that has a circumference on the atomic scale. For example, the diameter of single-wall nanotubes typically ranges from approximately 0.4 nanometers (nm) to approximately 100 nm, and most typically ranges from approximately 0.7 nm to approximately 5 nm.

The present disclosure provides methods and apparatuses for producing disperse boron nitride nanostructures as well as disperse nanostructures and composites comprising those disperse nanostructures. Any boron nitride nanostructure capable of being dispersed in a matrix material can be used according to the present disclosure.

In various aspects, the disperse nanostructures of the present disclosure are boron nitride nanotubes (BNNTs). In some aspects, the BNNTs are one-dimensional nanostructures made up of hexagonal B—N bonding networks, which are structural analogues of carbon nanotubes (CNTs). While the nature of the C—C bond in CNTs is purely covalent, the B—N bond has partial ionic character due to the differences in electronegativity of boron and nitrogen, resulting in BNNTs being electrically insulating with a band gap of about 5-6 eV that is insensitive to tube diameter, number of walls and chirality. BNNTs exhibit high chemical stability, thermal stability (up to 800 degrees C. in air), excellent thermal conductivity, very high Young's modulus (up to 1.3 TPa), piezoelectricity, the ability to suppress thermal neutron radiation, and superhydrophobicity (as a matted fabric). These properties make them ideal candidates as protective shields/capsules, mechanical and/or thermal reinforcement for polymers, ceramics and metals, self-cleaning materials and for biology/medicine applications.

BNNTs can be synthesized using a variety of methods including laser ablation, arc discharge, chemical vapor deposition, mechanothermal methods, and the like. In some aspects of the present disclosure, BNNTs are produced by the floating catalyst technique using ferrocene or nickelocene as catalysts and borazine or decaborane as precursors. Other precursors can be used for CVD growth including: diborane, trimethyl borate, elemental boron, iron boride, boric acid and boron tribromide, with or without ammonia and/or N₂ gas. Also, boron oxide gas formed from the reaction of boron with a metal oxide (SiO₂, MgO, FeO, Li₂O, and the like) can be used as precursor. In other aspects, catalysts for CVD growth of BNNTs include: Ni₂B, Co, Ni, NiB, Fe, Fe oxides, Ni oxides, and the like.

Like CNTs, BNNTs can suffer from severe bundling during their growth, resulting in aggregation and poor dispersion. Thus, in order to realize their potential in BNNT-reinforced composites, it is useful to first debundle and disperse the nanotubes. Existing methods rely on sonication in solvents, ball milling, mechanical mixing or functionalization.

In various aspects, the above-described methods for production and dispersion of CNTs can be applied to BNNTs. For example, in some aspects, the methods used for mixing pristine CNTs with an aerosolized matrix can be used for BNNTs. In various aspects, the plume of BNNTs is grown using a floating catalyst in which the catalyst is mixed with an aerosolized matrix as they exit the growth rector. Using this method, the continuous, homogeneous and in situ incorporation of pristine BNNTs into a matrix is achieved, with reduced agglomeration and bundling and precise control over loading amounts.

Boron nitride nanotubes can be synthesized in adequately pure form by ball-milling, chemical vapor deposition, arc discharge, substitution reactions, or other methods known to those skilled in the art.

The purification of boron nitride nanotubes, if required, can be carried out via the removal of elemental boron with nitric acid, with the removal of elemental boron and boron oxides with thermal annealing, with the removal of crystalline boron nitride with surfactant treatment, with ultrasonication, with centrifugation, and potentially with other techniques still in the investigational stages of development at this time.

The dispersion of boron nitride nanotubes in ceramic or metal matrices can be carried out via powder processing. This method involves mixing a solution of dispersed boron nitride nanotubes with a solution of ceramic or metal powder comprising one or more types of material. This mixture of solutions can then be rendered uniform via ultrasonication, planetary ball milling, wet-jet milling, bead milling, high-shear dispersion, high-pressure homogenization, sol-gel processing, or other methods known to those skilled in the art.

The end-result, wherein the boron nitride nanotubes are dispersed within the ceramic or metal matrix particles, is then dried, crushed into a fine powder, and dry-mixed prior to densification.

The dispersion of boron nitride nanotubes in ceramic or metal matrices can, alternatively, be carried out in situ via chemical vapor deposition. This method involves introducing nitrogen/ammonia gas and boron gas from a B₂O₃/boron powder mixture into a CVD reactor where the gasses coalesce into boron nitride nanotubes over a ceramic or metal particle or ceramic or metal particle/catalyst matrix. In one embodiment, the temperatures required for this procedure are in the 1000-1800 degrees Celsius range. In another embodiment, the temperatures required for this procedure are in from 1100-1400 degrees Celsius.

In various aspects, aerosols of nanostructures are formed in a reactor by a method comprising introducing a catalyst or catalyst precursor and a carbon precursor into the reactor, as described herein. In various aspects of the present disclosure, carbon nanostructures are produced within the reactor by the reaction of a carbon precursor with a catalyst. In various aspects, a plurality of catalyst particles is provided in the reactor either by direct introduction of the catalyst particles into the reactor or by production of the catalyst particles within the reactor from a catalyst precursor. Catalyst particles that form in the reactor can decompose the carbon precursor to produce an aerosol of carbon nanostructures. A promoter may also be introduced into the reactor to promote the decomposition of the carbon precursors into carbon nanostructures.

The catalyst may be introduced into the reactor in the form of a liquid, spray, or aerosol, and may comprise a plurality of colloidal particles. The catalyst can convert a carbon precursor into highly mobile carbon radicals that can rearrange to form carbon nanostructures. The plurality of catalyst particles can decompose the carbon precursor into a plurality of carbon nanostructures. The decomposition can be a thermal decomposition or a catalytic decomposition. Optionally, a promoter may also be added to promote the decomposition reaction. In some aspects, the promoter comprises a thiophene, carbon disulfide or other sulfur containing compound, tetrahydrofuran, dimethylformamide, dimethyl sulfoxide, or a combination thereof.

In some aspects of the present disclosure, chemical vapor deposition (CVD) is used for the production of carbon nanostructures, resulting in a controlled and uniform synthesis of nanostructures. In various aspects, carbon nanostructures are produced within a reactor and at the surface of a plurality of catalyst particles. According to this method, a precursor is introduced into a reactor along with a carrier gas, which is typically an inert gas. A catalyst, which can be introduced into the reactor as active catalytic particles or as precursors that can be converted into active catalytic particles in situ, can decompose the precursor, initiating the growth of the nanostructure at the catalytic site. As described herein, a carrier gas introduced into the apparatus can help carry the reactants and products from one structure of the apparatus or portion thereof to another. The carrier gas may be an inert gas, such as an argon gas, hydrogen gas, helium gas, nitrogen gas, or a combination thereof. A first carrier gas, introduced into the reactor via a gas inlet of the catalyst or catalyst precursor injector, can help carry the catalyst particles through the catalyst particle growth zone of the reactor, into the nanostructure growth zone.

The production of the nanostructures in the reactor may be controlled in many ways. The temperature in the reactor may be varied to optimize the efficiency of reactions or to control the rate of reactions. Producing an aerosol of nanostructures may be performed at a temperature selected from a temperature from 200° C. to 1800° C., from 300° C. to 1600° C., from 400° C. to 1600° C., from 500° C. to 1600° C., from 600° C. to 1600° C., from 700° C. to 1400° C., and from 800° C. to 1400° C.

Another alternate method for dispersing boron nitride nanotubes in ceramic or metal matrices involves chemical or colloidal processing. This can be done via the introduction of anionic surfactants to an aqueous boron nitride nanotube suspension, along with the introduction of cationic surfactants to an aqueous ceramic or metal suspension. Following the introduction of the surfactants, both solutions are ultrasonicated separately, and are then mixed and ultrasonicated together. The charge-stabilized mixture is then dried, washed-off, and reduced to a fine powder for densification.

In a particularly preferred embodiment of the present invention, powder processing is employed. Boron nitride nanotubes and a ceramic or metal powder are dispersed in acetone and ultrasonicated for a period not to exceed three hours. This mixture is then wet-jet milled in a Sugino “Star Burst 10” mill for a period not to exceed three hours. The resulting slurry is dried, crushed, filtered, and mixed.

An additional embodiment of the present invention proposes reinforcing ceramic or metal matrices with boron nitride nanorods. These may be synthesized via a reaction between boron tribromide and sodium amide in a lithium bromide molten salt medium at 600° C. Alternatively, they may be synthesized via annealing ball-milled boron carbide powders at 1300° C. in a nitrogen gas atmosphere. An alternate synthesis involves UV-laser irradiation of a hexagonal boron nitride precursor at a pressure of 50 MPa.

In one embodiment of the present invention, the dispersal of boron nitride nanorods in ceramic or metal matrices involves making a suspension of the nanorods and the ceramic or metal powder in a liquid solvent medium, followed by a lengthy period of ultrasonication, followed by high-shear dispersion, followed by drying, crushing into a fine powder, and dry-mixing. In other embodiments of the invention milling, and/or homogenization, may be employed instead of high-shear dispersion, and ultrasonication may not be required.

An additional embodiment of the present invention proposes reinforcing ceramic or metal matrices with cubic boron nitride nanocrystals. A still further embodiment of the present invention proposes reinforcing ceramic or metal matrices with wurtzite boron nitride nanocrystals. Both forms of nanocrystal are ultrahard in themselves, and should impart a significant hardening effect when added to a ceramic or metal matrix.

Nanocrystal synthesis can be accomplished with high-pressure high temperature (HPHT) methods, well known to those with an ordinary skill in the art. Nanocrystal synthesis can, alternately, be accomplished with a low-pressure thermal method via a reaction between a boron trihalide or complex thereof—such as boron tribromide or boron trifluoride diethyl etherate—and lithium nitride, in an autoclave at elevated temperatures.

In one embodiment of the present invention, the dispersal of boron nitride nanocrystals in ceramic or metal matrices involves making a suspension of the nanocrystals in a liquid solvent medium, mixing with a ceramic or metal suspension, and wet-jet milling at elevated pressure. The composite powder is then dried and reduced to a fine powder. Said dispersion technique has the additional advantage of dramatically reducing particle and crystal size.

An additional embodiment of the present invention proposes reinforcing ceramic or metal matrices with boron nitride nanoparticles with a fullerene-like structure—including hollow clusters, onions, and nanopolyhedra—of the formula BₙNₙ, where n=12-120. In most embodiments of the invention, the boron nitride fullerene-like structures have the formula B₃₆N₃₆.

Boron nitride fullerene-like structures can be prepared via simple chemical routes, for instance via reacting sodium azide and boron tribromide in an autoclave for 8 hours at 500° C., followed by cooling to room temperature, followed by washing with solvents and drying under vacuum. Boron nitride fullerene-like structures can, additionally, be synthesized via pyrolysis, arc-melting and electron-beam irradiation.

The dispersal of boron nitride fullerene-like structures in ceramic or metal matrices is identical to the methods described for the dispersal of boron nitride nanotubes in ceramic or metal matrices. In a preferred embodiment of this invention, boron nitride fullerene-like nano-structures and a ceramic powder such as boron carbide are dispersed in acetone and ultrasonicated for a period not to exceed three hours. The slurry is then homogenized, ball-milled, or subject to extremely high-shear dispersion, for a period of approximately three hours. The resultant slurry is then dried, crushed, filtered, and dry-mixed.

A further embodiment of this invention proposes reinforcing ceramic or metal matrices with two-dimensional boron nitride nanostructures, such as nano-platelets, nano-sheets, or nano-ribbons. These two-dimensional nanomaterials are typically produced via the exfoliation of boron nitride powders in DMF by sonication and centrifugation—a mature technique that has enabled the production of bulk commercial quantities.

The dispersal of two-dimensional boron nitride nanostructures in ceramic or metal matrices differs in only one respect from the dispersal of boron nitride nanotubes: Ball milling would lead to unacceptable levels of degradation and damage to the boron nitride nanostructures; for this reason, less destructive methods, e.g., high-shear dispersion and homogenization—are preferred.

Once boron nitride nanomaterials are well dispersed in a ceramic or steel matrix, and the composite powder has been dried, characterized, and is deemed suitable for further processing, the composite powder may be processed into a green compact prior to sintering. This would involve slip casting, injection molding, or cold isostatic pressing. In a preferred embodiment of the present invention, the composite powder is cold isostatic pressed at elevated pressure to form a green compact.

The densification of boron nitride nanocomposite powders or green compacts can be accomplished with pressureless sintering, hot isostatic pressing, conventional hot pressing, or spark-plasma sintering (SPS)—the latter of which is also known as field assisted sintering technique (FAST), and as pulsed electric current sintering (PECS), although it must be noted that it may employ a non-pulsed current. In all instances, the composite powder or compact must be sintered in a non-oxidizing atmosphere at a temperature of 800 to 2500° C., and at a sintering pressure of from 0 to 200 MPa. The non-oxidizing atmosphere can be selected from a vacuum atmosphere or an inert gas atmosphere, such as N₂ or Ar. Furthermore, the aforementioned composite powder may further comprise at least one metal selected from among Al, Be, Ti, Mg, Ni, Co, Mo, Fe, Nb, or V. These metals can act as sintering aids, which may be added to improve the sinterability and densification kinetics of the composite material.

Following sintering, the composite material thus obtained may be grinded to reduce surface roughness. It is desirable to have a post-polishing surface roughness of 0.1 μm or less.

An alternate, steel-specific, processing method for dispersing boron nitride nanotubes in a molten iron or steel bath and densifying the resultant material involves the following: First, dispersing boron nitride nanomaterials in an organic solvent such as acetone or in a mixed water-surfactant solution via ball milling, homogenization, high-shear dispersion, or other methods. Next, adding this dispersed BNNT solution to a molten steel or iron bath in a dropwise manner. The molten steel/BNNT mixture is then subject to high-energy ultrasonication and mechanical agitation for a period of several hours. This is followed by casting, billet production, and, in some embodiments of the invention, heat-treatment. Maraging steel based composites are, lastly, subject to aging for a period of two or more hours.

In various aspects, the resultant nanostructure dispersion produced according to the present methods is a homogeneous mixture. In various aspects, the mixture comprises a plurality of individual nanostructures, wherein a nanostructure is an individual nanostructure if it is physically separated from other nanostructures. In the homogeneous mixture, greater than 70% of the nanostructures can be individual nanostructures, greater than 60% of the nanostructures can be individual nanostructures, greater than 50% of the nanostructures can be individual nanostructures, greater than 40% of the nanostructures can be individual nanostructures, greater than 30% of the nanostructures can be individual nanostructures, greater than 20% of the nanostructures can be individual nanostructures, greater than 10% of the nanostructures can be individual nanostructures, greater than 5% of the nanostructures can be individual nanostructures, from 5% to 70% of the nanostructures can be individual nanostructures, from 10% to 70% of the nanostructures can be individual nanostructures, from 15% to 70% of the nanostructures can be individual nanostructures, from 20% to 70% of the nanostructures can be individual nanostructures, from 25% to 70% of the nanostructures can be individual nanostructures, from 30% to 70% of the nanostructures can be individual nanostructures, from 35% to 70% of the nanostructures can be individual nanostructures, from 40% to 70% of the nanostructures can be individual nanostructures, from 45% to 70% of the nanostructures can be individual nanostructures, from 50% to 70% of the nanostructures can be individual nanostructures, from 5% to 50% of the nanostructures can be individual nanostructures, from 10% to 50% of the nanostructures can be individual nanostructures, from 15% to 50% of the nanostructures can be individual nanostructures, from 20% to 50% of the nanostructures can be individual nanostructures, from 25% to 50% of the nanostructures can be individual nanostructures, from 30% to 50% of the nanostructures can be individual nanostructures, from 35% to 50% of the nanostructures can be individual nanostructures, from 40% to 50% of the nanostructures can be individual nanostructures, from 45% to 50% of the nanostructures can be individual nanostructures, from 5% to 35% of the nanostructures can be individual nanostructures, from 10% to 35% of the nanostructures can be individual nanostructures, from 15% to 35% of the nanostructures can be individual nanostructures, from 20% to 35% of the nanostructures can be individual nanostructures, from 25% to 35% of the nanostructures can be individual nanostructures, from 5% to 30% of the nanostructures can be individual nanostructures, from 10% to 30% of the nanostructures can be individual nanostructures, from 15% to 30% of the nanostructures can be individual nanostructures, from 20% to 30% of the nanostructures can be individual nanostructures, from 25% to 30% of the nanostructures can be individual nanostructures, from 5% to 25% of the nanostructures can be individual nanostructures, from 10% to 25% of the nanostructures can be individual nanostructures, from 15% to 25% of the nanostructures can be individual nanostructures, from 20% to 25% of the nanostructures can be individual nanostructures, or essentially all of the nanostructures can be individual nanostructures.

Alternatively to or in combination with the individual nanostructures, the homogeneous mixture can also comprise non-individual nanostructures, wherein the non-individual nanostructures can be comprised in a plurality of nanostructure bundles. Essentially all of the non-individual nanostructures can be comprised in a plurality of nanostructure bundles, at least 99% of the non-individual nanostructures can be comprised in a plurality of nanostructure bundles, at least 95% of the non-individual nanostructures can be comprised in a plurality of nanostructure bundles, at least 90% of the non-individual nanostructures can be comprised in a plurality of nanostructure bundles, at least 85% of the non-individual nanostructures can be comprised in a plurality of nanostructure bundles, at least 80% of the non-individual nanostructures can be comprised in a plurality of nanostructure bundles, at least 75% of the non-individual nanostructures can be comprised in a plurality of nanostructure bundles, or at least 70% of the non-individual nanostructures can be comprised in a plurality of nanostructure bundles.

The homogeneous mixture can comprise a plurality of nanostructure bundles, wherein the plurality of nanostructure bundles can comprise a plurality of nanotube bundles. The homogeneous mixture can also comprise a mixture of individual nanostructures and a plurality of nanostructure bundles, wherein the nanostructure bundles can comprise nanotube bundles. Each of the bundles of nanostructures can comprise an average of 90 or fewer nanostructures, each of the bundles of nanostructures can comprise an average of 80 or fewer nanostructures, each of the bundles of nanostructures can comprise an average of 70 or fewer nanostructures, each of the bundles of nanostructures can comprise an average of 60 or fewer nanostructures, each of the bundles of nanostructures can comprise an average of 50 or fewer nanostructures, each of the bundles of nanostructures can comprise an average of 40 or fewer nanostructures, each of the bundles of nanostructures can comprise an average of 35 or fewer nanostructures, each of the bundles of nanostructures can comprise an average of 30 or fewer nanostructures, each of the bundles of nanostructures can comprise an average of 25 or fewer nanostructures, each of the bundles of nanostructures can comprise an average of 20 or fewer nanostructures, each of the bundles of nanostructures can comprise an average of 15 or fewer nanostructures, each of the bundles of nanostructures can comprise an average of 14 or fewer nanostructures, each of the bundles of nanostructures can comprise an average of 13 or fewer nanostructures, each of the bundles of nanostructures can comprise an average of 12 or fewer nanostructures, each of the bundles of nanostructures can comprise an average of 11 or fewer nanostructures, each of the bundles of nanostructures can comprise an average of 10 or fewer nanostructures, each of the bundles of nanostructures can comprise an average of 9 or fewer nanostructures, each of the bundles of nanostructures can comprise an average of 8 or fewer nanostructures, each of the bundles of nanostructures can comprise an average of 7 or fewer nanostructures, each of the bundles of nanostructures can comprise an average of 6 or fewer nanostructures, each of the bundles of nanostructures can comprise an average of 5 or fewer nanostructures, each of the bundles of nanostructures can comprise an average of 4 or fewer nanostructures, each of the bundles of nanostructures can comprise an average of 3 or fewer nanostructures, or each of the bundles of nanostructures can comprise an average of 2 or fewer nanostructures.

Further, each of the bundles of nanostructures can comprise an average of from 3 to 15 nanostructures, each of the bundles of nanostructures can comprise an average of from 4 to 15 nanostructures, each of the bundles of nanostructures can comprise an average of from 5 to 15 nanostructures, each of the bundles of nanostructures can comprise an average of from 5 to 14 nanostructures, each of the bundles of nanostructures can comprise an average of from 5 to 13 nanostructures, each of the bundles of nanostructures can comprise an average of from 5 to 12 nanostructures, each of the bundles of nanostructures can comprise an average of from 5 to 11 nanostructures, each of the bundles of nanostructures can comprise an average of from 5 to 10 nanostructures, each of the bundles of nanostructures can comprise an average of 15 or fewer nanostructures, each of the bundles of nanostructures can comprise an average of 14 or fewer nanostructures, each of the bundles of nanostructures can comprise an average of 13 or fewer nanostructures, each of the bundles of nanostructures can comprise an average of 12 or fewer nanostructures, each of the bundles of nanostructures can comprise an average of 11 or fewer nanostructures, each of the bundles of nanostructures can comprise an average of 10 or fewer nanostructures, each of the bundles of nanostructures can comprise an average of 9 or fewer nanostructures, each of the bundles of nanostructures can comprise an average of 8 or fewer nanostructures, each of the bundles of nanostructures can comprise an average of 7 or fewer nanostructures, each of the bundles of nanostructures can comprise an average of 6 or fewer nanostructures, each of the bundles of nanostructures can comprise an average of 5 or fewer nanostructures, each of the bundles of nanostructures can comprise an average of 4 or fewer nanostructures, each of the bundles of nanostructures can comprise an average of 3 or fewer nanostructures, or each of the bundles of nanostructures can comprise an average of 2 or fewer nanostructures.

The nanostructure bundles can have an average diameter of 2 nm to 100 nm. In some, the nanostructure bundles can have an average diameter of 10 nm to 90 nm. In some, the nanostructure bundles can have an average diameter of 20 nm to 80 nm. In some, the nanostructure bundles can have an average diameter of 30 nm to 70 nm. In some, the nanostructure bundles can have an average diameter of 40 nm to 60 nm. In some, the nanostructure bundles can have an average diameter of less than 100 nm. In some, the nanostructure bundles can have an average diameter of less than 80 nm. In some, the nanostructure bundles can have an average diameter of 50 nm to 10 nm. In some, the nanostructure bundles can have an average diameter of less than 60 nm.

Properties of the resultant nanostructure dispersion can be controlled in a variety of ways. The loading amount (mass fraction or weight percentage) of the nanostructures in the matrix can be modulated to tune the resultant nanostructure dispersion, and can be determined based at least one desired property of the carbon-reinforced composite material to be formed using the nanostructure dispersion. For example, the percent weight of the nanostructures in the matrix can be controlled to be in the range from about 0.001 wt. % to about 50 wt. %, particularly about 0.01 wt. % to about 20 wt. %, and more particularly about 0.01 wt % to about 10 wt. %. The loading amount of the nanostructure in the matrix can be controlled in various ways. For example, the amount of time for which the aerosol of nanostructures is mixed with the matrix material or particles can be varied. Alternatively, or in combination, the duration of nanostructure synthesis can be modulated while the rate of nanostructure synthesis is held constant, or the quantity of the matrix material provided in the mixing chamber can be modulated.

The types of nanostructures formed (e.g., single-walled carbon nanotubes, multi-walled carbon nanotubes, etc.) and their physical properties (e.g., length of nanotubes) can also impact the properties of the resultant nanostructure dispersions. These parameters can be controlled by varying one or more synthesis conditions of the nanostructures, including reaction temperature, carrier gas flow rate, carbon precursor composition, catalyst composition, and promoter composition. The nanostructure dispersion particles can be mechanically deformable and/or pulverizable. The particles can have an initial average particle size of about 0.1 μm to about 500 μm or to about 0.5 μm to about 250 μm. The shape of the particles can be regular or irregular, and can, for example, be spherical or oblong.

The ceramic or steel matrix nanocomposites of the present invention are useful in applications requiring extreme toughness, hardness, and strength. They may be used for ballistic armor applications, as load-bearing structural articles, or for extreme-stress nuclear and aerospace applications—particularly given boron nitride's favorable characteristics as a radiation-shielding material.

The carbon-reinforced composite materials comprising the nanostructure dispersions produced using the methods described herein are useful for preparing aspects of, elements of, parts of, portions of, or the like, for applications in, but not limited to, automotive, aerospace, oil and natural gas industries. Carbon-reinforced composite materials may also be useful in applications currently available for graphite fibers and other high-strength fibers, such as structural support and body panels or brakes for vehicles, aircraft components, spacecraft, marine applications such as boat hull structures, sporting goods such as sailboards and skis, structural components for homes, furniture, tools, and implants and prostheses. They may also be useful in battery applications such as supercapacitor and fuel cells, in energy storage devices such as anodes, cathodes or hydrogen storage materials, and in electronics applications such as heat sinks for thermal management.

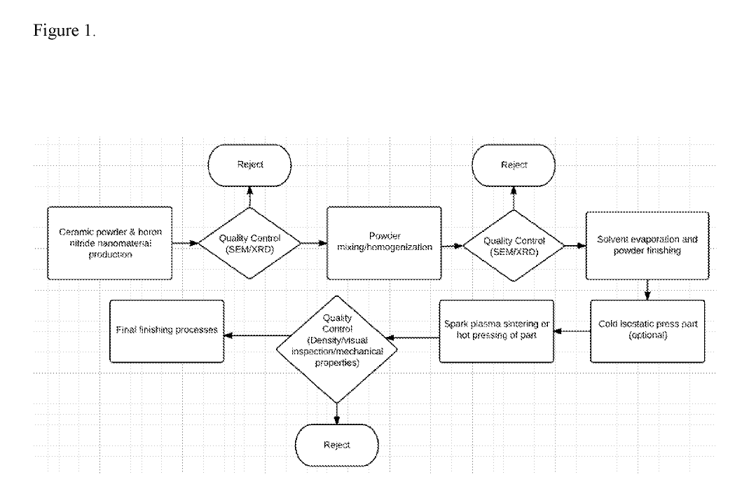

FIG. 1 illustrates a flow chart showing the process of making metal and ceramic matrix composites reinforced with boron nitride nanomaterials. In the above-described flow chart of FIG. 1, the method may be embodied in an automated manufacturing system that performs a series of functional processes. In some implementations, certain steps of the methods are combined, performed simultaneously or in a different order, or perhaps omitted, without deviating from the scope of the disclosure. Thus, while the method blocks are described and illustrated in a particular sequence, use of a specific sequence of functional processes represented by the blocks is not meant to imply any limitations on the disclosure. Changes may be made with regards to the sequence of processes without departing from the scope of the present disclosure. Use of a particular sequence is therefore, not to be taken in a limiting sense, and the scope of the present disclosure is defined only by the appended claims.

It must be noted that, as used in this specification and the appended claims, the singular forms “a,” “an” and “the” include plural referents unless the content clearly dictates otherwise. Thus, for example, reference to a “colorant agent” includes two or more such agents.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

As will be appreciated by one having ordinary skill in the art, the methods and compositions of the invention substantially reduce or eliminate the disadvantages and drawbacks associated with prior art methods and compositions.

It should be noted that, when employed in the present disclosure, the terms “comprises,” “comprising,” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

While it is apparent that the illustrative embodiments of the invention herein disclosed fulfill the objectives stated above, it will be appreciated that numerous modifications and other embodiments may be devised by one of ordinary skill in the art. Accordingly, it will be understood that the appended claims are intended to cover all such modifications and embodiments, which come within the spirit and scope of the present invention.

What is claimed is:

1. A material reinforced with a boron nitride nanomaterials, comprising either:
(a) A ceramic matrix composite comprising a crystalline ceramic matrix and a boron nitride nanomaterial reinforcement;
(b) A steel matrix composite comprising a predominantly ferrous matrix and an effective amount of boron nitride nanomaterial reinforcement.

2. The composite of claim 1, wherein the ceramic matrix is a carbide, a boride, or elemental carbon or boron.

3. The composite of claim 1, wherein the steel matrix is a maraging steel of the formula Ni[1]Co[2]Mo[3]Ti[3]Al[4]Be[4]Zr[4]B[4], where [1]=8-30%, [2]=4-25%, [3]=0-12%, [4]=0-5%, with the balance being Fe.

4. The composite of claim 1, wherein the steel matrix is a low-alloy steel of predominantly bainitic morphology.

5. The composite of claim 1, wherein the steel matrix is a stainless steel of predominantly bainitic morphology.

6. The composite of claim 1, wherein the steel matrix is a low-alloy steel of predominantly austenitic morphology.

7. The composite of claim 1, wherein the steel matrix is a stainless steel of predominantly austenitic morphology.

8. The composite of claim 1, wherein the steel matrix is TRIP steel of austenitic-ferritic morphology.

9. The matrix composite of claim 1, wherein said nanomaterials are boron nitride nanotubes.

10. The matrix composite of claim 9, wherein said nanotubes are single-walled boron nitride nanotubes.

11. The matrix composite of claim 9, wherein said nanotubes are dual-walled boron nitride nanotubes.

12. The matrix composite of claim 9, wherein said nanotubes are multi-walled boron nitride nanotubes.

13. The matrix composite of claim 9, wherein said nanotubes are boron nitride nanotubes with a bamboo-like morphology.

14. The matrix composite of claim 1, wherein said nanomaterials are boron nitride nanorods.

15. The matrix composite of claim 1, wherein said nanomaterials are cubic boron nitride nanocrystals.

16. The matrix composite of claim 1, wherein said nanomaterials are wurtzite boron nitride nanocrystals.

17. The matrix composite of claim 1, wherein said nanomaterials are boron nitride fullerene-like molecular structures of the formula BnNn, where n=12-120.

18. The matrix composite of claim 1, wherein said nanomaterials are boron nitride nanoplatelets, nanosheets, or nanoribbons.

19. A method for producing ceramic composites having improved mechanical properties comprising:
combining a boron nitride nanomaterial and a ceramic powder or powder matrix
homogenizing the new blended composite via high-shear dispersion, ball milling, wet-jet milling, or other techniques known to those skilled in the art
reducing to a free-flowing powder
forming an article therefrom, and
sintering the article at elevated temperature and/or elevated pressure.

20. A method for producing steel composites having improved mechanical properties comprising:
combining a boron nitride nanomaterial and a steel powder or powder matrix
homogenizing the new blended composite via high-shear dispersion, ball milling, wet-jet milling, or other techniques known to those skilled in the art
reducing to a free-flowing powder
forming an article therefrom, and
sintering the article at elevated temperature and/or elevated pressure.

21. A method for producing steel composites having improved mechanical properties comprising:
dispersing boron nitride nanotubes in a liquid solvent via high-shear dispersion, ball milling, homogenization, or other techniques known to those skilled in the art
slowly adding this boron nitride nanotube solution to a molten steel bath
high-energy ultrasonication and mechanical agitation of the molten metal bath
followed by vacuum degassing, casting, billet production, and optionally ageing/heat-treatment.
